(19) United States
(12) Patent Application Publication
(10) Pub. No.: US 2008/0126376 A1
(43) Pub. Date: May 29, 2008

(54) ENABLING MULTI-VIEW APPLICATIONS BASED ON A RELATIONAL STATE MACHINE PARADIGM

(76) Inventors: Avraham Leff, New Hempstead, NY (US); James T. Rayfield, Ridgefield, CT (US)

Correspondence Address: LAW OFFICE OF IDO TUCHMAN (YOR), 82-70 BEVERLY ROAD, KEW GARDENS, NY, 11415, US

(21) Appl. No.: 11/534,299

(22) Filed: Sep. 22, 2006

(51) Int. Cl. G06F 7/00

(52) U.S. Cl. 707/101

(57) ABSTRACT

A method and apparatus for constructing a software application with a plurality of screens. Operations performed in the method include representing a data model of the computer application as a relational model, providing a first screen of the computer application representing a current state of the data model, using relational algebra to define control logic of the computer application as a mapping from the current state of the data model and zero or more current application inputs to a new state of the data model and zero or more application outputs, using relational algebra to specify the selection of a second screen as a function of the current state of the data model and zero or more current application inputs, and generating computer executable code displaying the first screen and the second screen on a display.

### CROSS-REFERENCE TO RELATED APPLICATIONS

The present invention is related to U.S. patent application Ser. No. 11/341,557 titled “METHODS AND APPARATUS FOR CONSTRUCTING DECLARATIVE COMPONENTIZED APPLICATIONS” and filed Jan. 26, 2006, the entire contents of which are incorporated herein by reference.

### FIELD OF THE INVENTION

The present invention relates to approaches for building and executing interactive applications that contain multiple views by assembling encapsulated components whose inputs and outputs are based on a relational model and executing these applications using a relational state machine paradigm.

### BACKGROUND OF THE INVENTION

Declarative programming promises to increase productivity by allowing programmers to define applications (or parts thereof) based on what the application should do, rather than how the application should do it. This is in contrast to imperative programming, which envisions programs as a sequence of commands (statements) applied to the program state. Although declarative and imperative programming are often described as opposites, in practice they form a spectrum. At one extreme, fully imperative programming specifies all the low-level details about the implementation of an application, such as “load the value 5 into register zero.” At the other extreme, fully declarative programming specifies no details about the implementation of an application: “Computer, build me an order-entry application!”

In reality, high-level languages such as C and Java avoid the necessity of programming at a fully imperative level; for its part, declarative programming has not yet advanced to the point of allowing single-sentence descriptions of complex applications. Even so, computer scientists seek to move the level of abstraction further towards the declarative end of the spectrum, because a more concise description of the application should lead (in general) to higher productivity. In other words, if low-level details can be omitted by the programmer, she should be able to write programs more quickly. Productivity is enhanced because programmers are free to concentrate on defining the application's function, and are not distracted by considerations of how that function is achieved.

Declarative programming has been successfully applied to View construction such as Web pages that are written in HTML. Programmers describe only what the Web page should look like; web-browsers are responsible for providing the algorithms that render the page onto a display's pixels. Application Models can also be described declaratively. For example, relational database schema can be described by the DDL subset of SQL, and XML document structure can be specified by schema. Finally, application logic (Controllers) can be described in declarative fashion using functional languages (e.g., Haskell and Lisp), logic-based languages (e.g, Prolog), and constraint-based languages (e.g, Oz). XML document instances can be manipulated in a declarative fashion using languages such as XSLT, and navigated using query languages such as XPath and XQuery.

Despite such examples, and despite the promise of increased productivity, most applications continue to be built using imperative programming techniques. This may be because humans tend to think and plan in a sequential style. Imperative programming allows an “incremental” approach to implementing an application since one can start coding without fully understanding everything that needs to be accomplished. Alternatively, it may be because most introductory programming courses are taught with imperative programming languages. More fundamentally, there may be problems with existing declarative approaches that make them less productive than imperative approaches. For example, popular declarative languages only cover part of the application development space. HTML (without scripting) cannot be used to build spreadsheets, and XSLT cannot be efficiently used to build messaging systems. Although separate declarative technologies may exist for different portions of the application space, there is generally no existing way to integrate the different portions into a single coherent application.

### BRIEF SUMMARY OF THE INVENTION

One exemplary aspect of the present invention is a method for providing a computer application with a plurality of screens. The method includes representing a data model of the computer application as a relational model. A first screen is provided of the computer application representing a current state of the data model. Using relational algebra, control logic is defined for the computer application as a mapping from the current state of the data model and zero or more current application inputs to a new state of the data model and zero or more application outputs. Using relational algebra, a selection of a second screen is specified as a function of the current state of the data model and zero or more current application inputs.

Another exemplary aspect of the invention is an apparatus for providing a software application with a plurality of screens. The apparatus includes a memory and at least one processor coupled to the memory. The processor is operative to represent a data model of the computer application as a relational model, provide a first screen of the computer application representing a current state of the data model, use relational algebra to define control logic of the computer application as a mapping from the current state of the data model and zero or more current application inputs to a new state of the data model and zero or more application outputs, and use relational algebra to specify the selection of a second screen as a function of the current state of the data model and zero or more current application inputs.

Yet another exemplary aspect of the invention is an application development service for developing a computer application. The application development service includes an application server and a relational database coupled to the application server. Application data used by the computer application is stored in a relational database. An application development environment is provided that includes a graphical workspace transmittable to a remote developer computer. The application development environment includes at least one model block moveable within the graphical workspace and providing access to the application data, at least one view block moveable within the graphical workspace and representing a user interface widget with zero or more view input pins for receiving application data and zero or more output pins for presenting user data, at least one control block moveable within the graphical workspace for performing relational algebraic operations on data from the relational database provided by the model block and the user input provided by the view block, and at least one embedded composite block representing a new screen.

### BRIEF DESCRIPTION OF THE SEVERAL VIEWS OF THE DRAWINGS

FIG. 1 shows an exemplary environment embodying the present invention.

FIG. 2 shows relationships between various screens of an illustrative e-commerce computer application developed by an application development environment contemplated by the present invention.

FIG. 3 shows a browser-based visual editor provided by the application development environment and used to develop computer applications.

FIG. 4 shows a “Search Results” composite block at development time as represented by an exemplary visual editor contemplated by the present invention.

FIG. 5 shows that resulting “Search Results” screen during program execution.

FIG. 6 shows a flowchart for executing an application created using the application development environment of the present invention.

FIG. 7 shows an exemplary computer configuration embodying the present invention.

### DETAILED DESCRIPTION OF THE INVENTION

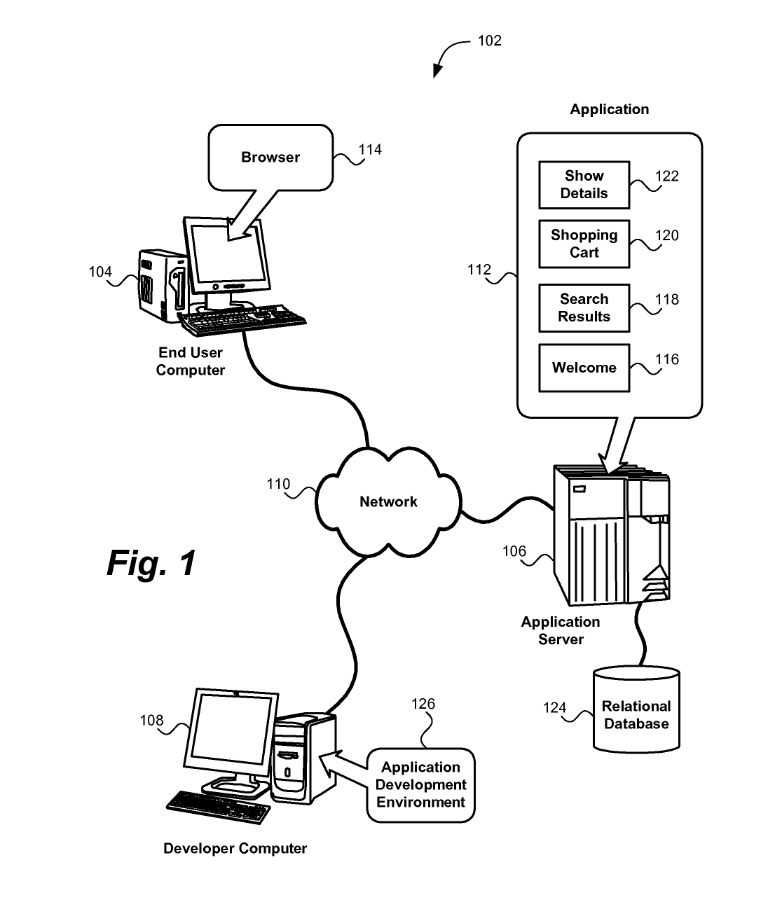

The present invention will be described with reference to embodiments of the invention. Throughout the description of the invention reference is made to FIGS. 1-7. When referring to the figures, like structures and elements shown throughout are indicated with like reference numerals.

FIG. 1 shows an exemplary environment 102 embodying the present invention. It is initially noted that the environment 102 is one of countless configurations in which the present invention could be employed. Thus, the environment 102 is presented for illustration purposes and is not intended to limit the scope of the present invention.

The environment 102 includes an end user computer 104, an application server 106, and a developer computer 108 coupled via a computer network 110. The application server 106 executes a computer application 112. The computer application 112 can be any application necessary to interact with the end user. For example, the application 112 may be an e-commerce application allowing the end user to purchase items using a browser 114 running at the end user computer 104.

The application 112 may provide the end user several pages that are displayed at the browser 114. These pages may include a welcome page 116, a search results page 118, a shopping cart page 120, and a show details page 122. For example, when the end user computer 104 initially connects with the application server 106, the application 112 may provide the end user computer 104 the welcome page 116. As the end user electronically shops for items, the application 112 may provide the end user computer 104 a shopping cart page 120 displaying the items selected by the end user for purchase.

Thus, in one embodiment of the invention, the application 112 is a multi-screen (multi-page) HTML-based application. In such an embodiment, the end user computer 104 and the application server 106 typically communicate via the computer network 110 using an HTTP protocol. Those skilled in the art will appreciate that other embodiments of the application 112 are possible, including stand-alone “rich client” applications with multiple screens.

As used herein, the term “screen” refers to one or more instances of user interface widgets presented to the user. In typical embodiments, a new screen is embodied as a new page or a new view displayed by the application. A new screen may not necessarily replace all existing user interface widgets presented by the application. For example, a new screen may occupy only a frame in an application window. Furthermore it is contemplated that a screen may comprise non-visual widgets, such as audio inputs and/or outputs.

Data used by the application 112 is represented as a relational model. In a particular embodiment of the invention, application data is stored on a relational database 124. A database management system (not shown) is typically used to create and manage the relational database 124. Examples of database management systems include, but are not limited to, DB2 Universal Database, Oracle, Microsoft SQL Server, MySQL, and custom database management systems.

As discussed in more detail below, the application 112 is modeled as a relational state machine such that application states are maintained within the relational database 124. Relational algebra is used to control the application's transition from one state to another. Furthermore, state transitions are initiated by various events, such as external events (e.g., a user clicking a button in the user interface) or internal events (e.g., a database trigger).

The developer computer 108 includes an application development environment 126 for graphically creating the application 112. In a particular embodiment of the invention, the application development environment 126 is implemented using the Graphical Editor Framework (GEF) (www.eclipse.org/gef), an Eclipse (www.eclipse.org) tools project. In another embodiment, the application development environment 126 is implemented in JavaScript and runs in a web browser, and composite designs are represented in XML, and stored by a server. As described in detail below, the application development environment 126 allows relational blocks to be dragged and dropped onto a two-dimensional canvas. Relational blocks include input and/or output “pins” that can be connected to provide program functionality. Once the relational blocks are organized and interconnected according to the application's specifications, the application development environment 126 generates computer readable code for affecting the functionality of the relational blocks.

Any suitable computer usable or computer readable medium may be utilized to store the generated application 112. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device. Computer usable program code may be transmitted using any appropriate medium, including but not limited to the Internet, wireline, optical fiber cable, RF, etc.

In a particular embodiment of the present invention, the relational blocks are abstracted to a Model-View-Controller design pattern. As such, the relational blocks utilized by the application development environment 126 include:

1. Model block: The model block is expressed as a set of relations (tables). Visually, a model block takes the form of a mathematical table, as in existing visual tools for relational database design. The model block may consist of persistent and/or transient portions (this is an application design issue; the application development environment 126 makes no distinction between persistent and transient model blocks). The model block has an output, which is the current state of the database 124, and an input, which is the desired next state of the database 124.

2.View block: The view block is expressed visually, by laying out widgets to form the desired user interface view. Program-writeable widgets have an input, expressed as a relation. For example, a label might have a single tuple with text and font attributes. Program-readable widgets have an output, expressed as a relation. For example, a slider might have a have a single tuple with a single attribute value in its output. Note that read/write widgets (e.g., text boxes) effectively become part of the Model block, since they act as a mini database. More complicated widgets such as tables and lists are multi-tuple relations. The view block widgets are thus directly compatible with the model and controller blocks.

3. Controller block: The controller block is described declaratively using relational algebra. Inputs to controller blocks are the current state of model blocks and the current values of view blocks with readable widgets. The output of control blocks is the next state of the model block and the next state of writeable view block widgets.

4. Composite block: The composite block is a collection of model, view and/or controller blocks for a particular view. Composite blocks can be embedded in a composite block. Furthermore, embedded composite blocks include an enable pin that, when activated, causes view blocks at the enabled composite block to be displayed in a new screen. When an embedded composite block is enabled, control passes to the relational blocks contained in the enabled composite block.

5. Macro block: The macro block contains at least one model block, controller block or view block by reference. Macro blocks are used to simplify application design by packaging complex functionality in a representative block.

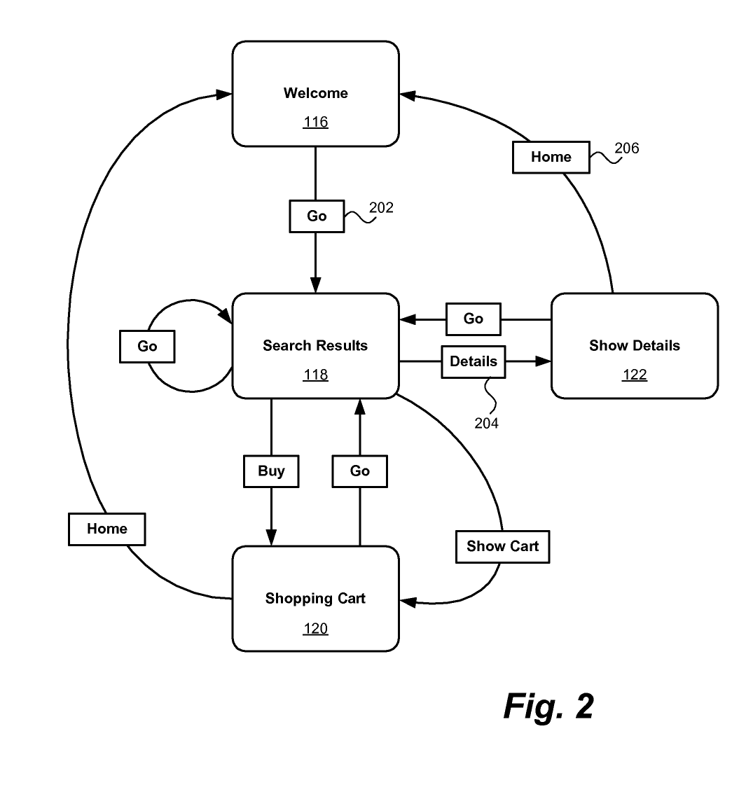

FIG. 2 shows the relationships between various screens of an illustrative e-commerce computer application developed by an application development environment contemplated by the present invention. Specifically, four screens are present: a Welcome screen 116 (a “welcome to the application” page), a Search Results screen 118 (showing the results of a search), a Shopping Cart screen 120 (showing the current contents of the shopping cart), and a Show Details screen 122 (showing details for a single product).

Also shown are the possible navigation paths to and from each screen. For example, clicking a Go button 202 at the Welcome screen 116 will transition the application to the Search Results screen 118. Clicking a Details button 204 at the Search Results screen 118 transitions the application to the Show Details screen 122. It should be noted that other widgets beyond buttons may be used by the present invention to transition to different views, such as, but not limited to, slides, checkboxes, tabs and dials. It is further contemplated that screen transitions may be caused by internal database events rather than widget activation events.

As discussed in more detail below, during execution, the computer application provides a first screen representing a current state of the application data model. The computer application transitions to a second screen using relational algebra to define control logic as a mapping from the current state of the data model and zero or more current application inputs to a new state of the data model and zero or more application outputs. Furthermore, the application specifies the selection of a second screen as a function of the current state of the data model and zero or more current application inputs using relational algebra.

For example, consider the situation where the current state of the application is such that the Show Details screen 122 is displayed to the user. When the user clicks the Home button 206 at the Show Details screen 122, the application receives notification of this event and evaluates the new state of each model block. State changes are determined by using relational algebra. Further more, relational algebra is used to determine that second screen to be displayed at the new state is the Welcome screen 116.

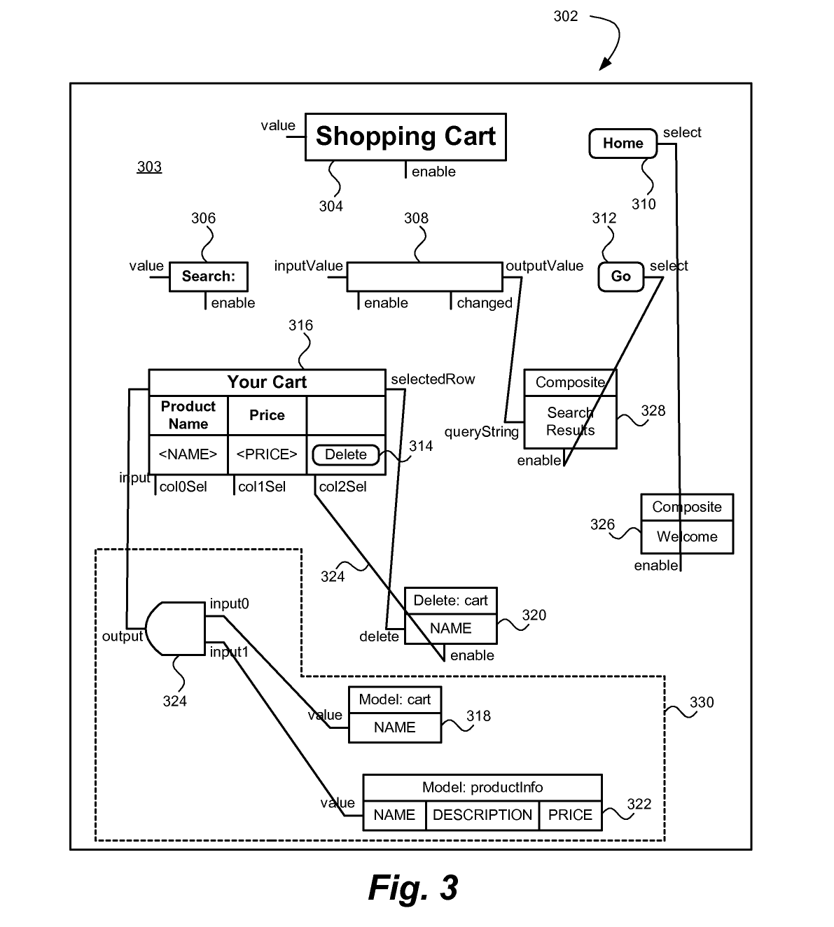

FIG. 3 shows a browser-based visual editor provided by the application development environment and used to develop computer applications. Specifically, FIG. 3 illustrates a graphical workspace 302 for a single composite block 303, the “Shopping Cart” composite block, at development time. A composite block represents an application screen presented to the end user, along with the underlying functionality thereof. A composite block is assembled from one or more additional blocks (model block, view block, controller block, embedded composite block), each of which has zero or more input pins and zero or more output pins. In a particular embodiment of the invention, relational blocks are added to the composite block 303 by dragging and dropping the blocks onto the workspace. Composite block assembly is performed by drawing a wire from one block's output pin to one or more input pins. Such wires represent the data flow of relational data from one block to another with the precise operation of the system defined by a relational state machine algorithm.

In accordance with an embodiment of the present invention, application state is described by a relational database. (Note that the application state may be transient, rather than persistent.) Furthermore, state transitions are initiated by various events (typically user action, such as clicking a button in the user interface; another event source might be internal events, such as database triggers). Each event executes the following algorithm:

1. Evaluate the inputs to all model blocks. Typically, this is a recursive process, because the inputs depend on the outputs of other controller blocks, model blocks and view blocks.

2. Each model block then updates its state, using the values just calculated in step 1. In this step, the relational state machine transitions to the next state. Future evaluations of model block outputs will equal this new state.

3. All writeable view blocks update their state based on their current inputs. Note that the view block is thus updated synchronously by the event-handler, and asynchronously by the user (typically by typing and/or clicking on the screen).

As shown in FIG. 3, the developer has assembled a set of view blocks, model blocks, controller blocks, and embedded composite blocks. The view blocks are: text labels 304 and 306, text-input field 308, buttons 310, 312 and 314, and HTML table 316. The model blocks are read block 318 (read access to the cart database table), delete block 320 (delete access to the cart database table), and read block 322 (read access to the productinfo database table). The controller block is join block 324 (a relational Join operation block).

The workspace 302 shows how user-initiated interactions with view blocks are linked to model and controller blocks. For example, clicking on the Delete button 314 is linked to the action of deleting the corresponding item from the shopping cart. Specifically, the select output pin for the Delete button 314 (“col2Sel” from table block 316) is connected by a wire 324 to the “enable” pin of the Delete model block 320. Thus, when the Delete button 314 is clicked, the Delete model block 320 causes the data identified by the “selectedRow” output pin of table 316 to be deleted, thus removing the indicated item from the Shopping Cart.

The assembly of at least one model block, and/or view block, and/or controller block is packaged into a composite block. Thus, view blocks 304 to 316, model blocks 318 to 322, and controller block 324 are packaged to create the “Shopping Cart” composite block 303. The workspace 302 also specifies that the Shopping Cart composite block 303 may transition to two other composite blocks 326 and 328 that cause new screens to be displayed. Clicking on the “Home” button 310 specifies a transition to the “Welcome” screen by activating the enable pin at the embedded Welcome composite block 326. Clicking on the “Go” button 312 specifies a transition to the “Search Results” screen by activating the enable pin for the embedded Search Results composite block 328.

Potential screen transitions are thus represented as embedded composite blocks. The target screens are not contained within the design in which they appear, but are rather references to other composites representing screens. For example, the “Welcome” screen and its underlying functionality is represented by embedded composite block 326, and the “Search Results” screen with its underlying functionality is represented by embedded composite block 328. Composite block transitions are specified by drawing a wire from one of the relational blocks in the Shopping Cart composite block 303 to an enable pin of an embedded composite block. The enable pin of an embedded composite block accepts a Boolean-valued relation. Thus, inter-composite block transitions are specified using the identical visual representation and relational semantics as intra-composite block data flows. Thus, in one embodiment of the invention, an embedded composite block is a design-time visual representation that expresses a transition from a first screen (i.e., “Shopping Cart” screen) to a second screen (i.e., “Welcome” screen) as a relation-valued input pin (i.e., the enable pin of composite block 326) on a visual representation of the second screen.

The “Search Results” embedded composite block 328 requires input data supplied to its “queryString” pin by view block 308. In this example, the data is supplied by a text-input widget into which the user enters the desired query string. Composite block 328 demonstrates how inter-composite block data flows are specified using identical visual representation and relational semantics as intra-composite block data flows. Thus, an embedded composite block may further provide a design-time visual representation that expresses data flow into the second screen as one or more relation-valued input pins (i.e., the “queryString” pin of view block 308).

As mentioned above, macro blocks may also be used in a composite block to simplify application development. For example, model block 318, model block 322 and controller block 324 contained in dotted line 330 can be placed into a macro block. The resulting macro block would include an output pin associated with the data present at the output pin of controller block 324. Macro blocks can be used in a hierarchical and reusable fashion, much like subroutines and functions in imperative programming languages.

It is contemplated that in other embodiments of the present invention non-visual representations of composite blocks may be used. For example, widget locations may be specified as X and Y coordinates, and relational algebra expressions may be specified in appropriate text language form.

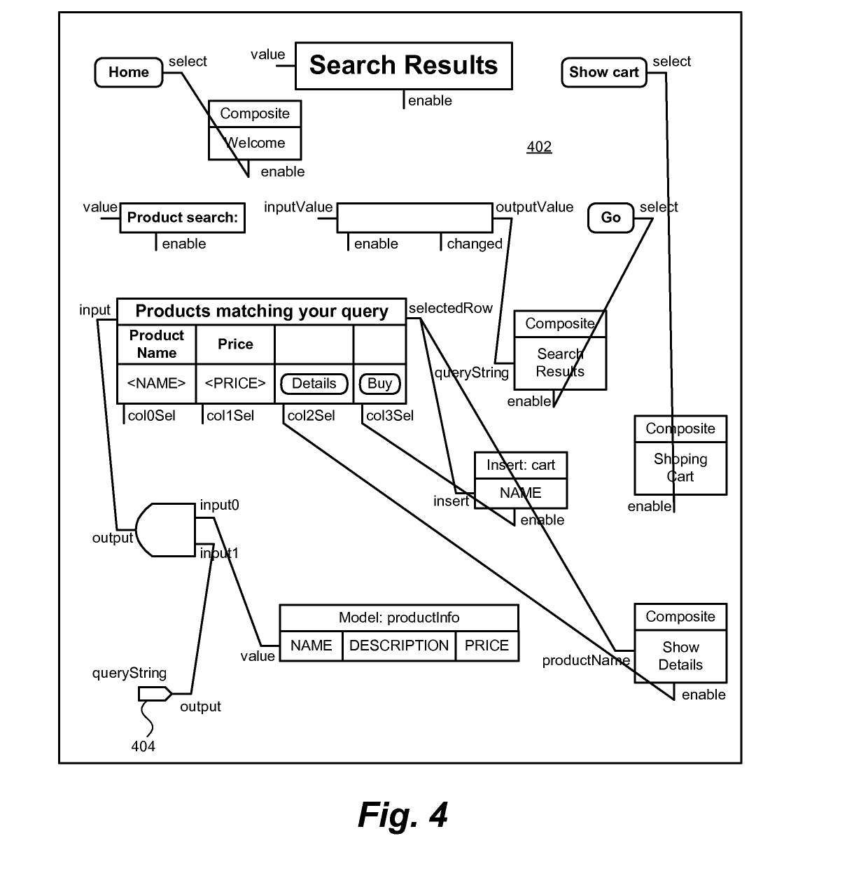

Turning to FIG. 4, the “Search Results” composite block 402 at development time as represented by an exemplary visual editor contemplated by the present invention is shown. Composite block 402 specifies than any incoming transition made from the other composite block must provide a data flow that involves a single input pin 404 (“queryString”). In an embodiment of the present invention, input pins added to a composite block result in the appearance of an input pin on its corresponding embedded composite block.

As mentioned above, the application development environment for creating applications may be presented on a browser. Thus, one embodiment of the present invention may be an application development web service for developing a computer application. The service may include an application server and a relational database coupled to the application server. Application data (including application state) is stored in the relational database. The service provider may receive revenue from various parties. For example, the service provider may receive revenue from the application developer, the end user, and/or a third party, such as an advertiser with advertisements displayed to the developer and/or end user during application development and/or use.

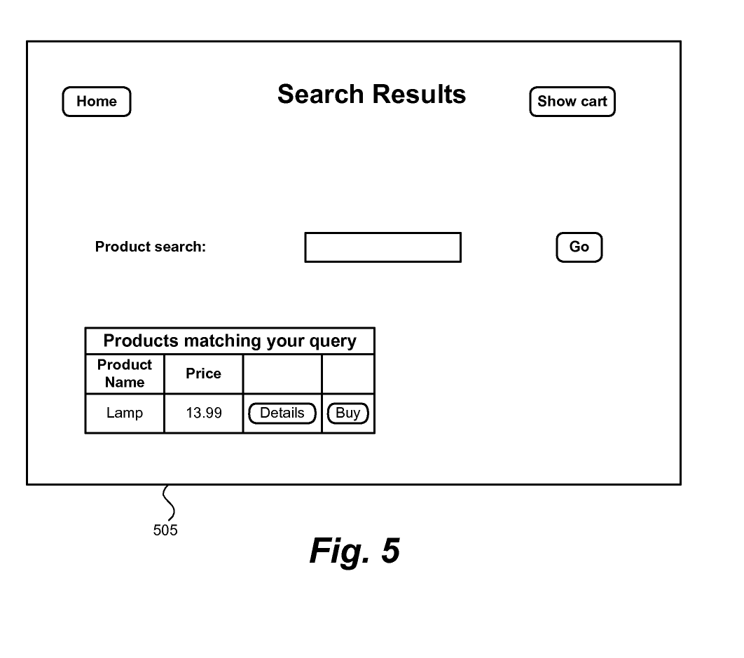

FIG. 5 shows that resulting “Search Results” screen 505 at execution. It is noted that only the view blocks are visible to the end user at execution time.

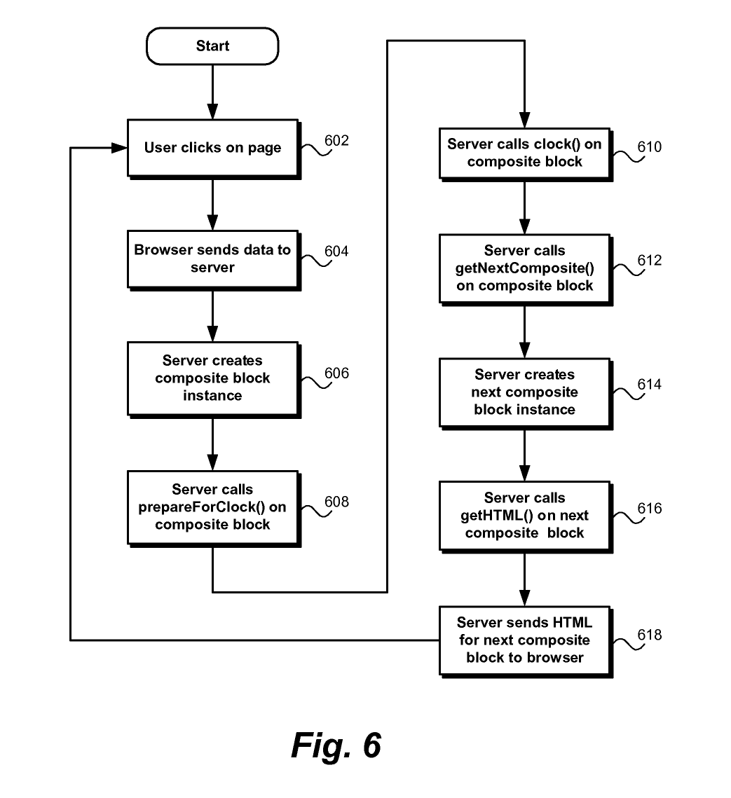

Referring now to FIG. 6, the process for executing an application created using the application development environment of the present invention is discussed. Computer program code for carrying out operations of the present invention may be written in an object oriented programming language such as Java, Smalltalk, C++ or the like. Alternatively, the computer program may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Process flow begins at step 602, where a user clicks on an HTML widget, such as such as a button, selector, input field, etc. At step 604, the browser sends all the form data on the screen to the server using HTTP POST. At step 606, the server creates a (server-side) instance of the current composite block (corresponding to the screen which the user clicked on in step 602).

At step 608, the server calls a prepareForClock( ) method on the current composite block. The composite block in turn calls a prepareForClock( ) method on all its contained model blocks. This causes the contained model blocks to evaluate all their input values. This is typically a recursive process, because model block inputs are connected to other model, view, and control blocks that must in turn evaluate their inputs.

At step 610, the server calls a clock( ) method on the current composite block. The composite block in turn calls the clock( ) method on all its contained model blocks. This causes all model blocks to change their internal (and output) state to match the values determined during processing of the prepareForClock( ) method. In this manner the next state is latched into the application state machine.

At step 612, the server calls a getNextComposite( ) method on the composite block. The getNextComposite( ) method determines which composite block will be represented in the next screen. The composite block implements this method by checking all embedded composites to determine which one is enabled. In one embodiment, at most one embedded composite block may be enabled. If more than one embedded composite block is enabled, an error condition is flagged. If no composite block is enabled, the current composite block is also the next composite block (i.e., the screen does not change).

At step 614, the server creates a server-side instance of the next composite block (or uses the current composite block if no embedded composite is enabled). At step 616, the server calls a getHTML( ) method on the next composite block (which may be the current composite block as discussed above) in order to get the HTML coding for the next screen. The next composite block may access data from the current composite block if the next composite block has input pins (e.g. input pin 404 in FIG. 4).

At step 618, the server sends the HTML for the next composite block back to the browser, and the next screen is displayed for the user. Control flow passes back to step 602, where the process repeats indefinitely.

When an application is started, it is necessary to “bootstrap” the process in order to display an initial page from a composite block without requiring that a user click on an HTML widget as in step 602. In one embodiment, this is accomplished by creating a launch composite block that contains no view block, and has exactly one embedded composite that is enabled. The launch composite block begins execution at step 612, and continues with steps 614 to 618. In other embodiments, the server creates the initial composite block directly, by assuming default or user-supplied values for the application input(s) (View widget(s) and/or composite input pins).

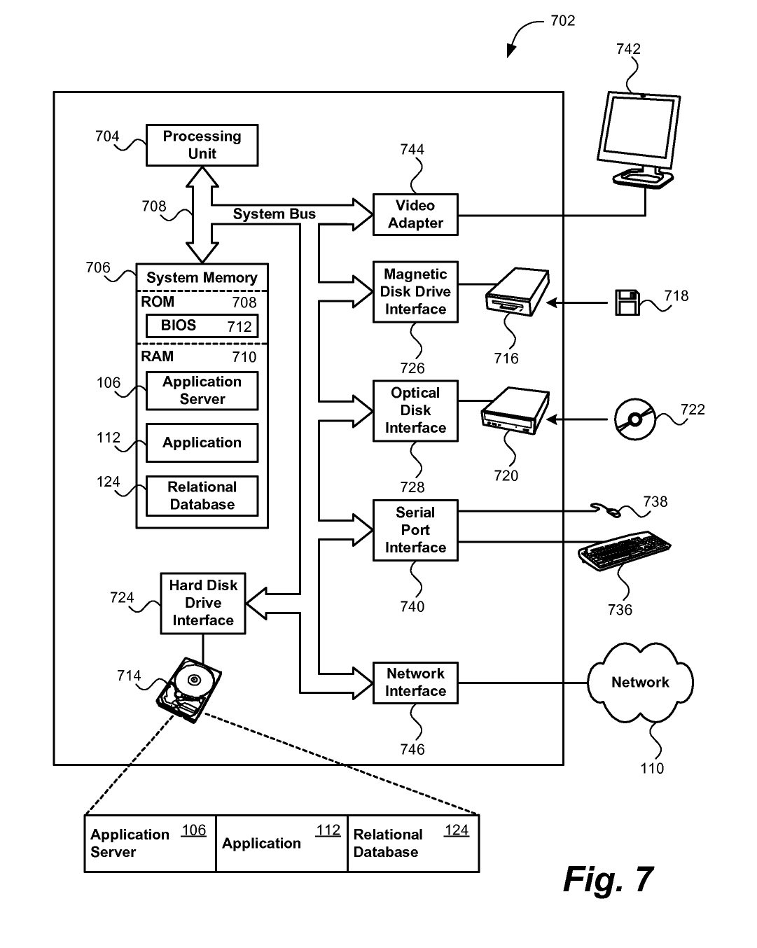

With reference to FIG. 7, an example of a computer 702 embodying the present invention is shown. One computer 702 in which the present invention is potentially useful encompasses a general-purpose computer. Examples of such computers include SPARC(r) systems offered by Sun Microsystems, Inc. and Pentium(r) based computers available from Lenovo Corp. and various other computer manufacturers. SPARC is a registered trademark of Sun Microsystems, Inc. and Pentium is a registered trademark of Intel Corporation.

The computer 702 includes a processing unit 704, a system memory 706, and a system bus 708 that couples the system memory 706 to the processing unit 704. The system memory 706 includes read only memory (ROM) 708 and random access memory (RAM) 710. A basic input/output system (BIOS) 712, containing the basic routines that help to transfer information between elements within the computer 702, such as during start-up, is stored in ROM 708.

The computer 702 further includes a hard disk drive 714, a magnetic disk drive 716 (to read from and write to a removable magnetic disk 718), and an optical disk drive 720 (for reading a CD-ROM disk 722 or to read from and write to other optical media). The hard disk drive 714, magnetic disk drive 716, and optical disk drive 720 are connected to the system bus 708 by a hard disk interface 724, a magnetic disk interface 726, and an optical disk interface 728, respectively. The drives and their associated computer-readable media provide nonvolatile storage for the computer 702. Although computer-readable media refers to a hard disk, removable magnetic media and removable optical media, it should be appreciated by those skilled in the art that other types of media that are readable by a computer, such as flash memory cards, may also be used in the illustrative computer 702.

Programs and data may be stored in the drives and RAM 710, including an application server 106, one or more applications 112, a relational database 124, and other program modules and data (not shown). As discussed above, the application server 106 is configured provide the application 112.

A user may enter commands and information into the computer 702 through a keyboard 736 and pointing device, such as a mouse 738. Other input devices (not shown) may include a microphone, modem, joystick, game pad, satellite dish, scanner, or the like. These and other input devices are often connected to the processing unit through a serial port interface 740 that is coupled to the system bus 708.

A display device 742 is also connected to the system bus 708 via an interface, such as a video adapter 744. In addition to the display device, the computer 702 may include other peripheral output devices (not shown), such as speakers and printers.

The computer 702 operates in a networked environment using logical connections to one or more remote devices. The remote device may be a server, a router, a peer device or other common network node. When used in a networking environment, the computer 702 is typically connected to a network 748 through a network interface 746. In a network environment, program modules depicted relative to the computer 702, or portions thereof, may be stored in one or more remote memory storage devices. The network 748 may be any of various types of networks known in the art, including local area networks (LANs), wide area networks (WANs), wired and/or wireless networks. The network 748 may employ various configurations known in the art, including by example and without limitation TCP/IP, Wi-Fi®, Bluetooth® piconets, token ring, optical and microwave. Wi-Fi is a registered trademark of the Wi-Fi Alliance, located in Austin, Tex. Bluetooth is a registered trademark of Bluetooth SIG, Inc., located in Bellevue, Wash. It is noted that the present invention does not require the existence of a network.

The flowchart and block diagrams in the Figures illustrate the architecture, functionality, and operation of possible implementations of systems, methods and integrated circuits according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

That which is claimed is:

1. A method for providing a computer application, the computer application including a plurality of screens, the method comprising:
representing a data model of the computer application as a relational model;
providing a first screen of the computer application representing a current state of the data model;
using relational algebra to define control logic of the computer application as a mapping from the current state of the data model and zero or more current application inputs to a new state of the data model and zero or more application outputs; and
using relational algebra to specify the selection of a second screen as a function of the current state of the data model and zero or more current application inputs.

2. The method of claim 1, further comprising providing a design-time visual representation that expresses a transition from the first screen to the second screen as a relation-valued input pin on a visual representation of the second screen.

3. The method of claim 1, further comprising providing a design-time visual representation that expresses data flow into the second screen as one or more relation-valued input pins.

4. The method of claim 1, wherein the relational model is a stored in a relational database.

5. The method of claim 4, further comprising:
providing at least one view block representing a user interface widget;
providing at least one model block representing access to application data stored at the relational database;
providing at least one controller block representing relational algebra operations performed on the application data; and
providing at least one composite block for transitioning from the first screen to the second screen; and
generating computer executable code enabling the functionality specified by the view block, model block, controller block and composite block.

6. The method of claim 5, further comprising packaging the composite block to include at least one of the model block and/or the controller block.

7. The method of claim 5, further comprising selecting the second screen based on the current state of the data model and zero or more output pins of the view block.

8. The method of claim 1, further comprising generating computer readable code for displaying the first screen and the second screen on a display.

9. An apparatus for providing a software application with a plurality of screens, comprising:
a memory; and
at least one processor coupled to the memory and operative to:
represent a data model of the computer application as a relational model;
provide a first screen of the computer application representing a current state of the data model;
use relational algebra to define control logic of the computer application as a mapping from the current state of the data model and zero or more current application inputs to a new state of the data model and zero or more application outputs;
use relational algebra to specify the selection of a second screen as a function of the current state of the data model and zero or more current application inputs.

10. The apparatus of claim 9, wherein the processor is further operative to provide a design-time visual representation that expresses a transition from the first screen to the second screen as a relation-valued input pin on a visual representation of the second screen.

11. The apparatus of claim 9, wherein the processor is further operative to provide a design-time visual representation that expresses data flow into the second view as one or more relation-valued input pins.

12. The apparatus of claim 9, wherein the relational model is a relational database.

13. The apparatus of claim 9, wherein the processor is further operative to:
provide at least one view block representing a user interface widget;
provide at least one model block representing access to application data stored at the relational database;
provide at least one controller block representing relational algebra operations performed on the application data; and
provide at least one composite block for transitioning from the first screen to the second screen; and
generate computer executable code enabling the functionality specified by the view block, model block, controller block and composite block.

14. The apparatus of claim 13, wherein the processor is further operative to package the composite block to include at least one of the model block or controller block.

15. The apparatus of claim 13, wherein the processor is further operative to select the second screen based on the current state of the data model and zero or more output pins of a view block.

16. The apparatus of claim 13, wherein the processor is further operative to provide at least one macro block, the macro block including at least one model block, view block or controller block by reference.

17. An application development service for developing a computer application, the application development service comprising:
an application server;
a relational database coupled to the application server, the relational database storing application data used by the computer application;
an application development environment including a graphical workspace transmittable to a remote developer computer, the application development environment comprising:
at least one model block moveable within the graphical workspace, the model block providing access to the application data;
at least one view block moveable within the graphical workspace, the view block representing a user interface widget, the view block including zero or more view input pins for receiving application data and zero or more view output pins for presenting user input;
at least one control block moveable within the graphical workspace for performing relational algebraic operations on data from the relational database provided by the model block and the user input provided by the view block; and
at least one embedded composite block representing a new screen.

18. The application development service of claim 17, wherein the application server is configured to execute the computer application as relational state machine such that application states are maintained within the relational database.

19. The application development service of claim 17, wherein executing the computer application comprises using relational algebra to define control logic of the computer application as a mapping from a current state of the application data and zero or more current application inputs to a new state of the application data and zero or more application outputs.

20. The application development service of claim 19, wherein executing the computer application further comprises:
evaluating data inputs to each model block;
updating each model block to the new state based on its evaluated data inputs; and
updating each writeable view block to the new state after updating each model block.
